(19) United States
(12) Patent Application Publication
(10) Pub. No.: US 2014/0308635 A1
(43) Pub. Date: Oct. 16, 2014

(54) SYSTEM AND METHOD FOR GENERATING A TRAVEL STRESS INDEX

(71) Applicant: CWT Global B.V., Diemen (NL)

(72) Inventors: Catalin Ciobanu, St. Germain en Laye (FR); Vincent Lebunetel, Boulogne-Billancourt (FR)

(73) Assignee: CWT Global B.V., Diemen (NL)

(21) Appl. No.: 13/959,502

(22) Filed: Aug. 5, 2013

Related U.S. Application Data
(60) Provisional application No. 61/812,598, filed on Apr. 16, 2013.

(51) Int. Cl. G09B 19/00

(52) U.S. Cl. CPC G09B 19/00
USPC 434/236

(57) ABSTRACT

A method for calculating a traveler stress index may include retrieving a dataset including transaction data on a plurality of trips from a storage device; calculating, using at least one processor, a maximum possible lost time value for each respective trip in at least a first subset of the plurality of trips; calculating, using the at least one processor, an actual lost time value for each respective trip in the first subset; summing the calculated maximum possible lost time values and actual lost time values to determine a total MPLT value for the first subset and a total ALT value for the first subset, respectively; and generating a stress index for the first subset by dividing the ALT value by the MPLT value.

### CROSS-REFERENCE TO RELATED PATENT DOCUMENTS

This patent application claims the benefit of priority, under 35 U.S.C. §119(e), to U.S. Provisional Patent Application Ser. No. 61/812,598, titled “SYSTEM AND METHOD FOR GENERATING A TRAVEL STRESS INDEX,” filed on Apr. 16, 2013, which is incorporated by reference in its entirety.

### TECHNICAL FIELD

This patent document pertains generally to quantification of stress, and more particularly, but not by way of limitation, to a system and method of generating a travel stress index.

### BACKGROUND

Business travel involves many potentially stressful activities such as losing luggage or flight delays. Various studies have reported on the harmful effects of increased stress on productivity. Stress prevention was found not only to reduce costs to a business but also to improve productivity of travelers.

### BRIEF DESCRIPTION OF DRAWINGS

Some embodiments are illustrated by way of example and not limitation in the figures of the accompanying drawings in which:

FIG. 1 illustrates an example trip analyzer component block diagram.

FIG. 2 is a schematic view of a computer network system, according to various examples, which may be used to calculate a traveler stress index for a company or group of companies.

FIG. 3 is a flowchart of an example method of calculating a Travel Stress Index (TSI) for a dataset.

FIG. 4 is an example report interface.

FIG. 5 is a block diagram of a machine in the example form of a computer system within which a set instructions, for causing the machine to perform any one or more of the methodologies discussed herein, may be executed.

### DETAILED DESCRIPTION

The following detailed description includes references to the accompanying drawings, which form a part of the detailed description. The drawings show, by way of illustration, example embodiments. These embodiments, which are also referred to herein as “examples,” are described in enough detail to enable those skilled in the art to practice aspects of the inventive subject matter. In this document, the terms “a” or “an” are used, as is common in patent documents, to include one or more than one. In this document, the term “or” is used to refer to a nonexclusive or, unless otherwise indicated.

When a person travels (e.g., for a business trip), there are many events that may cause stress. For example, with respect to air travel, a person may become stressed if his or her luggage is lost or if a flight is delayed. Stress may also be experienced during travel to and from the airport or if the hotel the person is staying at has no Internet connection. In various examples, when a person is experiencing stress, the productivity of the person may not be as high as if the person was not experiencing stress. Similarly, when a person is not as productive there may be a potential corresponding monetary loss by an employer of the traveler. Accordingly, various examples discussed herein discuss systems and methods to quantify the stress experienced by a traveler through the concept of a Travel Stress Index (TSI). In various examples, the TSI helps a company/management/organization to understand and measure how and to what extent traveler stress accumulates during regular business trips.

In various examples, the TSI is based on a series of component metrics that are calculated using data from a variety of sources. For example, each trip may be conceptualized as having a plurality of potentially stressful activities, from booking to reimbursement covering pre-trip, during trip (transportation and destination-related elements), and post-trip. Associated stress may then be measured based on the duration and the perceived stress intensity for each activity. In various examples, each activity of the trip may be viewed as having two components: “stress free” time and “lost time.” In various examples, the metrics associated with the TSI may include the maximum possible lost time per trip (mplt), the actual lost time per trip (alt), and the financial equivalent (fe) of the actual lost time per trip. The TSI may defined as the ratio of the quantities: alt/mplt.

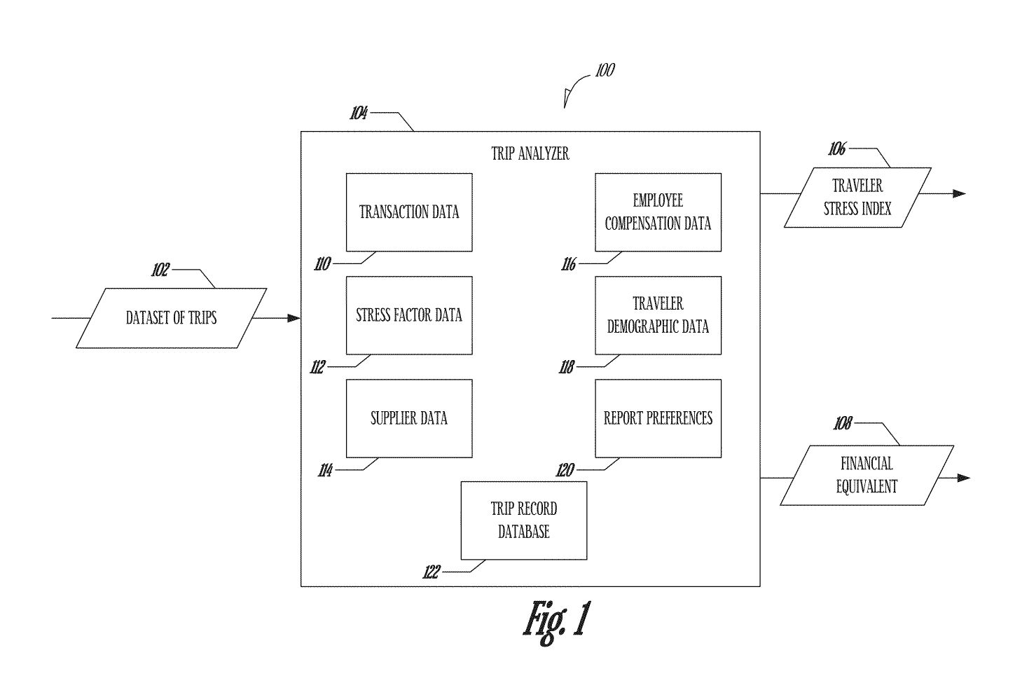

FIG. 1 illustrates a block diagram 100 of an example trip analyzer 104 component. The trip analyzer may include a set of instructions that are executed on a computing system to calculate the TSI and associated metrics. The computing system may be a single computer or distributed across multiple computers. Additionally, while the block components included in trip analyzer 104 are illustrated as separate components, the components may be joined or separated into additional components and distributed across multiple internal or external data sources without departing from the scope of this disclosure. In various examples, trip analyzer 104 takes a dataset of trips 102 as an input and outputs a traveler stress index 106 and financial equivalent 108. Trip analyzer 104 may include transaction data 110, stress factor data 112, supplier data 114, employee compensation data 116, traveler demographic data 118, report preferences 120, and trip record database 122. Other data may include a database of high-risk destinations.

In various examples, dataset of trips 102 includes data on a set of trips that are to be analyzed. The dataset may be for a single company or group of companies and may include data from multiple sources. For example, air travel information for a traveler may be retrieved from one source, and hotel information for a trip may be retrieved from another. Thus, in various examples, the dataset as received by trip analyzer 104 may not be in a standardized format; however, in other examples, the dataset may be partially or completely standardized. In an example, the dataset includes information to determine if and for how long a potentially stressful activity occurred during a trip.

In various examples, each trip in the dataset is subjected to a trip-reconstruction process. In an example, the trip-reconstruction process may include combining multiple sources of information to obtain a comprehensive view of any given trip in the dataset from booking to reimbursement with respect to the potentially stressful activities. After trip reconstruction, each trip may be in standardized format (e.g., a “comprehensive trip record” (CTR)) and stored in a database such as trip record database 122. In an example, the pieces (e.g., variables) of a CTR are used as inputs to obtain various metrics (e.g., those for calculating a TSI). Thus, the entire CTR may not be needed to obtain a metric. The metrics may then be used in any statistical analysis (average metric values, standard deviations, analysis uncertainties, confidence intervals, etc.) instead of the full set of CTR variables.

In various examples, a repository of information is created during trip reconstruction that brings together, for each trip, multiple pieces of information, such as:
Air booking information (fare, dates/times, carriers, origin-destination, etc.)
Hotel booking information (rate, dates/times, hotel information, etc.)
Ground transport/rental car information
External information (geopolitical context at destination, weather conditions, etc.)
Traveler demographic profile

Building the CTR may include pulling data that resides in different databases and, therefore, a certain amount of “trip matching” may be needed to bring the different components together. For example, if hotel and air data are stored in different places, one may use certain “keys,” such as the Passenger Name Record (PNR), to establish a one-to-one correspondence between an air transaction and the corresponding hotel stay. An example CTR format be as follows:

| | | | | | | | |
|---|---|---|---|---|---|---|---|
| AIR | RAIL | CAR | HOTEL | TRAV- | EMPLOYER | DESTI- | . . . |
| | | | | ELER | | NATION | |

Each category (e.g., box) in the CTR may include hundreds of variables related to the category.

In an example, an organization that is determining the TSI may be the same company that has booked the trips in the dataset. Accordingly, the discussion below may refer to internal and external sources with respect to that organization. As may be appreciated, the definition or internal and external sources may change depending on the perspective of the entity performing the TSI analysis.

In various examples, internal sources of information may include, but are not limited to, traveler demographic data 118, stress factor data 112, and transaction data 110. External sources of information may include, but are not limited to, information on flight delays, lost baggage, employee compensation data 116, and high-risk destinations.

In various examples, the internal sources focus on the transactional elements that are recorded for the main components of the trip: air bookings, hotel stays, and car rentals. An air booking may or may not have a hotel stay or car rental attached to it; this can happen, for example, for same-day return trips, one-way trips, and the like.

Transactional data 110 may include airport codes, dates (booking, departure, and return), flight time, connection information, fare paid, booking channel, and so forth. Supplier data 114 may include certain supplier information, such as hotel category or internet availability.

Traveler demographic data 118 may be determined using a traveler profile data store (e.g., relational database, non-relational database, Extensible Markup Language (XML) file, etc.) for the organization. The traveler data store may include demographics of the user for whom the trip is being reconstructed including, but not limited to, country of residence, age, gender, living with a partner or not, number of children, occupation level (e.g., associate, manager, director, vice president, senior vice president and above, or administrative and support roles), trip frequency in air trips/year (e.g., 5 or fewer, 6-10, 11-20, 21-30, and 31 or more), and number of languages spoken (e.g., 1, 2, 3, or 4 or more). The determined demographics of the traveler may then mapped be to the corresponding segment of stress factor data 112 to determine the appropriate set of parameters to be used for analyzing each trip.

Employee compensation data 116 (including social charges and benefits, averaged across industries) by country may be provided by external human resources community. This information may then be used to calculate the financial equivalent of the lost time (detailed further herein).

In various examples, stress factor data 112 stores perceived stress values for a variety of activities for different demographic groups. For example, the perceived stress values may be based on survey data. The survey data may include the perceived stress, of stress factor (SF) (e.g., on an index scale of 10-100) reported for multiple activities related to a typical business trip correlated with different demographic data. The below table presents 22 stress factors that may be included in such a survey. As may be appreciated, more or fewer stress factors, and different scales, may be used in a TSI analysis. Similarly, the SF strength values given are examples, and other values may be used (e.g., by conducting additional surveys or by manual adjustment).

During reconstruction of a trip, determining whether some stress factors occurred, such as flight delays, mishandled baggage and traveling to a high-risk destination, may involve receiving the data through the use of external data sources. For example, a flight status database may be queried with the flight number of a trip of a traveler (e.g., determined using internal transaction data) to determine if the flight was delayed or the average delay time for the flight.

| Stress Factor | Strength SF |
|---|---|
| Lost or Delayed Baggage | 79 |
| Poor/No Internet Connection | 77 |
| Flying Economy on Med/Long Haul | 73 |
| Delays | 72 |
| Low Hotel Category | 65 |
| Last-Minute Requested Trips | 63 |
| Traveling during Week-ends | 61 |
| Length of Journey to Reach Destination | 61 |
| Flying Indirect versus Direct | 61 |
| Getting through Customs and Security | 54 |
| Using Restricted Fares | 52 |
| Reimbursement | 51 |
| Geopolitical Context at Destination | 51 |
| (high risk destination) | |
| Long Stays (+3 nights) | 51 |
| Different Time Zone (jetlag) | 49 |
| Getting to the Airport/Station | 49 |
| Immigration Control at Destination | 47 |
| Using an Online Booking Tool | 42 |
| Flying Economy on Short Haul | 39 |
| Renting a Car | 37 |
| Contacting a Travel Agent | 37 |
| Taking a Taxi | 34 |

In an example, an algorithm to calculate the TSI is presented below. For example, consider the case of a given stress factor i, which acts over a time duration Tᵢ. As discussed previously, TSI survey data may include a defined strength of stress factor SFᵢ as the average reported stress on a scale of 10-100. For the current discussion it may be convenient to express this strength as a percentage Sᵢ (e.g., using the transformation: Sᵢ=(SFᵢ−10)/90) covering the range 0-1. With this notation, for Sᵢ=100%, the traveler experiences stress during the entire time Tᵢ. Conversely, for Sᵢ=0%, the traveler experiences no stress during Tᵢ.

More generally, the following two rules may be applied in an example:
1. If a stress factor i of strength Sᵢ acts over a duration Tᵢ then:
   a. Stress is experienced over a duration Sᵢ×Tᵢ
   b. The “stress-free” interval is Tᵢ−Sᵢ×Tᵢ. This time is available to the traveler to either work or rest.
2. If two or more stress factors act simultaneously during time Tᵢ, take into account the factor having the larger strength and discard the rest.
   In an example, the application of the second rule may be a conservative way to account to multiple stress factors.

In an example, the time over which stress is experienced (Sᵢ×Tᵢ) may also be referred to as “lost time” for the traveler. One goal may be to reduce this quantity and maximize the “stress-free” component. This may be achieved through a combination of steps geared toward reducing Tᵢ (e.g., flying direct versus indirect) and/or reducing Sᵢ (e.g., Internet connectivity in order to stay fully informed while on-the-go).

Consequently, in various examples, the analysis of a dataset is an exercise in “counting lost time.” More specifically, for a given dataset of trips, the following metrics may be calculated:
Maximum Possible Lost Time (MPLT)—In an example, defined as the sum of all durations Tᵢ across all possible stress activities i and across all trips in the set.
Actual Lost Time (ALT)—In an example, defined as the sum of all intervals Sᵢ×Tᵢ across all possible stress activities i and across all trips in the set.
   The TSI may then be defined as the ratio of ALT and MPLT:

$$T S I = \frac{A L T}{M P L T} = \frac{ActualLostTime}{MaximumPossibleLostTime}$$

In an example, the TSI values lie in the [0, 1] interval, but other intervals may be used. Also, for simplicity, MPLT and ALT are expressed as per-trip averages mplt and alt (e.g., obtained by dividing MPLT and ALT by the number of trips in the set). It may be noted that TSI=ALT/MPLT=alt/mplt.

As discussed previously, the “stress-free” time Tᵢ−Sᵢ×Tᵢ may be used by the traveler either to work or to rest. If work is carried out, it may represent a direct productivity gain. Rest may also be expected to increase productivity, though indirectly: resting “now” leads to productivity “later.” This indirect relationship may not be able to be readily quantified.

By the same token, lost time may not be precisely converted into lost productivity. However, a maximum productivity loss may be calculated if it is considered that the entire lost time, ALT, could have been converted into productive time. Thus, in an example, putting an upper limit on productivity loss may define a reference point for discussing the impact of travel on productivity.

Lastly, a financial equivalent (FE) may be calculated for the maximum productivity loss, using employee compensation data 116 (e.g., internal or external data source). In an example, FE, in essence, is the dollar equivalent of ALT. A per-trip average fe may be obtained by dividing FE by the number of trips in the set.

In various examples, using the defined variables above, a TSI model may be defined. A TSI model may be defined as the group of metrics used to calculate the TSI. These parameters may be divided into three categories:

Factor strengths Sᵢ

Tᵢ—related parameters

Financial parameters

As previously mentioned, the stress factor strengths Sᵢ may be obtained from a Travel Stress Index survey and stored, such as in stress factor data 112. In an example, traveler groups in a dataset may be divided into ten demographic categories and then the survey responses may be sorted accordingly. For example, if the person taking the trip is identified as a female within the 30-35 age range category, the set of stress strengths corresponding to this particular group may be used in calculating the trip's contributions to the lost time totals.

In an example, depending on the stress factor i, deriving the interval Tᵢ may require certain parameters, assumptions, or thresholds. For example, for those activities i requiring assumptions, a second set of survey results may be used. The second survey may ask travelers from different demographic categories to provide estimations of the time lost in situations where parameters of assumption are needed. The average across the responses may be used as the Tᵢ parameter of the TSI model.

A few examples are given below:
Flying economy on medium/long haul flights: Tᵢ=Flight Time. The flight time may be fully determined from the transaction details; thus, no assumptions may be needed. Different thresholds of time may also be used for determining if a flight qualifies as short, medium, or long.
Getting through customs and security: the maximum possible lost time contribution is Tᵢ=30 minutes and, given the strength of this factor, the actual lost time may be roughly 15 minutes. Transactional data may be needed as well: for a return trip one needs to account for these lost time contributions both on the inbound and the outbound legs of the trip.
Flight delays: Transactional data may be used to extract the origin-destination airport pair for each flight. External data may then be used to obtain the average delay corresponding to this airport pair; this delay represents the Tᵢ interval.
   In other words, depending on the given factor i, the Tᵢ duration may either be fully determined from the transactional data, or it may require certain assumptions and/or external data. In various examples, the Tᵢ duration for each factor i may be stored (such as in stress factor data 112) when appropriate (e.g., for those factors that do not rely on transaction data and are based on survey data).

In various examples, financial data may be used to calculate the financial equivalent of lost time. This data may include a benchmark cost of employment across all industries (compensation, benefits, and social charges) by job level in multiple (e.g., 58) countries around the globe and be stored as employee compensation data 116. The average cost of employment (e.g., hourly compensation rate) may be calculated based on the mix of job seniority among a group of travelers in a dataset.

In summary, the following quantities may be used to measure travel stress:
The maximum possible lost time per trip: mplt
The actual lost time per trip: alt
The travel stress index: TSI=alt/mplt
The financial equivalent fe of actual lost time per trip: the maximum possible lost time per trip. In an example, this definition indirectly implies that all lost time could have been ultimately converted into productive time. As a result, the fe should not be interpreted as the actual lost productivity, but rather as an estimation of the upper limit of lost productivity.

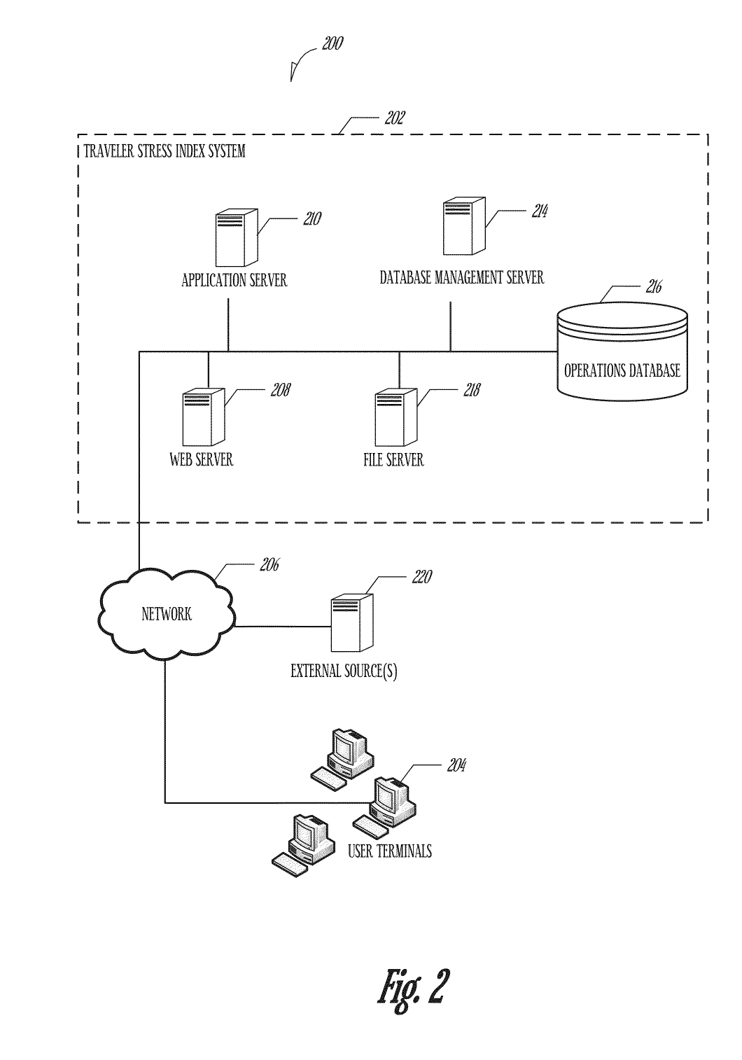

FIG. 2 is a schematic view of a computer network system 200, according to various examples, which may be used to calculate a traveler stress index for a company or group of companies. Computer network system 200 includes traveler stress index (TSI) system 202 and user terminal 204, communicatively coupled via network 206. In an example, TSI system 202 includes web server 208, application server 210, database management server 214, which may be used to manage at least operations database 216, and file server 218. TSI system 202 may be implemented as a distributed system (for example, one or more elements of TSI system 202 may be located across a wide-area network (WAN) from other elements of TSI system 202. As another example, a server (e.g., web server 208, file server 218, or database management server 214) may represent a group of two or more servers, cooperating with each other, provided by way of a pooled, distributed, or redundant computing mode.

Network 206 may include local-area networks (LANs), WANs, wireless networks (e.g., 802.11 or cellular networks), the Public Switched Telephone Network (PSTN) network, ad hoc networks, personal area networks (e.g., Bluetooth), or other combinations or permutations of network protocols and network types. The network 206 may include a single LAN or WAN, or combinations of LANs or WANs, such as the Internet. The various devices coupled to network 206 may be coupled to network 206 via one or more wired or wireless connections.

Web server 208 may communicate with file server 218 to publish or serve files stored on file server 218. Web server 208 may also communicate or interface with the application server 210 to enable web-based presentation of information. For example, application server 210 may consist of scripts, applications, or library files that provide primary or auxiliary functionality to web server 208 (e.g., multimedia, file transfer, or dynamic interface functions). In addition, application server 210 may also provide some or the entire interface for web server 208 to communicate with one or more of the other servers in the TSI system 202 (e.g., database management server 214). Web server 208, either alone or in conjunction with one or more other computers in TSI system 202, may provide a user-interface. The user-interface may be implemented using a variety of programming languages or programming methods, such as HTML (HyperText Markup Language), VBScript (Visual Basic® Scripting Edition), JavaScript™, XML® (Extensible Markup Language), XSLT™ (Extensible Stylesheet Language Transformations), AJAX (Asynchronous JavaScript and XML), Java™, JFC (Java™ Foundation Classes), and Swing (an Application Programming Interface for Java™).

User terminal 204 may be a personal computer (PC) or mobile device. In an embodiment, user terminal 204 includes a client program to interface with TSI system 202. The client program may include commercial software, custom software, open source software, freeware, shareware, or other types of software packages. In an embodiment, the client program includes a thin client designed to provide query and data manipulation tools for a user of user terminal 204. The client program may interact with a server program hosted by, for example, application server 210. Additionally, the client program may interface with database management server 214. For example, a user may use user terminal 204 to view a web-application provided by application server 210. The web-application may include input forms for a user to request a TSI for a dataset or view results of a previously conducted TSI analysis. In an example, a stand-alone application (e.g., desktop application) may be used to interact with TSI system 202.

Operations database 216 may be composed of one or more logical or physical databases. For example, operations database 216 may be viewed as a system of databases that, when viewed as a compilation, represent an “operations database.” Sub-databases in such a configuration may include an air-travel transaction database, traveler demographic database, stress factor survey results database, average time of stress activities database, employee compensation database, supplier information database (e.g., hotel categories, hotel amenity data), a comprehensive trip record database, and other databases storing data used in the calculation of a TSI. The operations database 216 may be implemented as a relational database, a centralized database, a distributed database, an object oriented database, or a flat database in various embodiments.

During operation, data from multiple data sources is imported into the operations database 216. Data sources may exist within an organization, such a travel sales department or survey results, or exist at an external source (e.g., external sources 220), such as resources that include information on compensation, average flight delays, lost luggage, and travel risk data. The data may be imported and stored in the operations database on a scheduled basis, such as weekly, monthly, quarterly, or some other regular or periodic interval. Alternatively, the data may be imported on-demand. For example, if a user requests that a TSI be calculated for a dataset, the external sources may be queried at the time of the request.

After data importation, the data may be standardized and then stored in a common database or data mart. For example, when calculating a TSI for a set of trips, a standardized format (e.g., XML, database schema) may be used. A user may not initially supply a dataset of trips in the standardized format and thus the dataset may be converted to the standardized format before being stored. Similarly, different external sources 220 may have data in different formats than what is stored in operations database 216. Data conditioning may include data rearrangement, normalization, filtering (e.g., removing duplicates), sorting, binning, or other operations to transform the data into a common format (e.g., using similar date formats, name formats, and address fields).

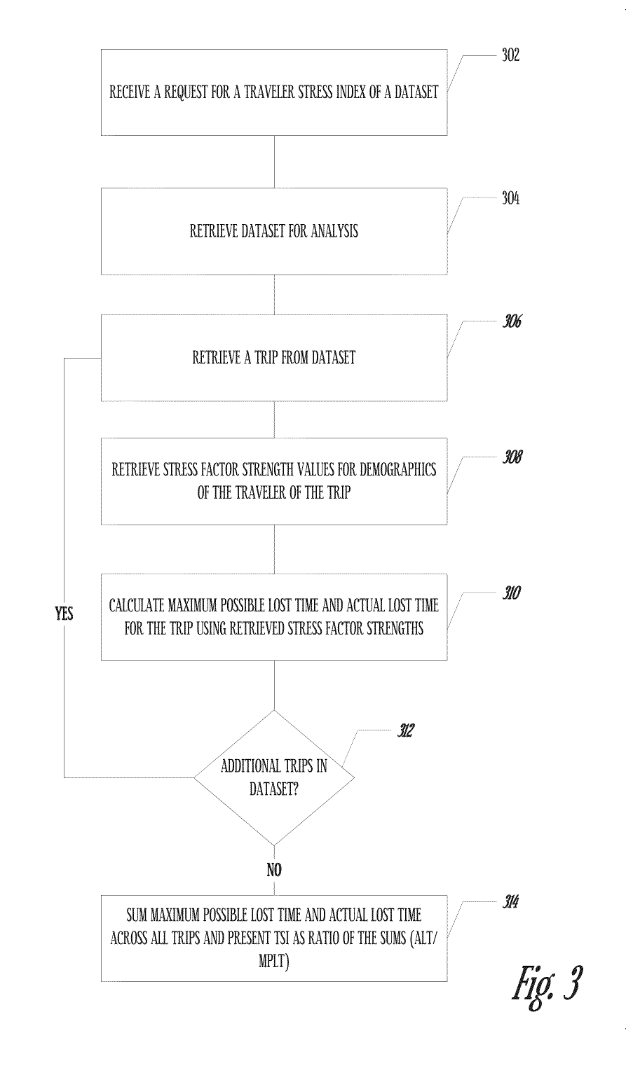

FIG. 3 is a flowchart of an example method of calculating a TSI for a dataset. In an example, a request for a TSI of a dataset is received (302). For example, a user may use user terminal 204 to request (e.g., via e-mail, website, mobile application, telephone, etc.) the TSI from an organization running TSI system 202. The request may define the request according to various parameters. For example, the request may specify a TSI analysis for a group of companies over a specific time frame in the dataset. The request may also include what outputs and breakdowns to include in a report (e.g., report preferences 120 with respect to FIG. 1).

In an example, TSI system 202 may then retrieve the dataset for analysis (304). For example, the organization may be the travel management company for the requester and thus may only need to access data stored in operations database 216 that includes travel data records of the requester's company. However, if some or all of the travel data records are not already available, the dataset may be received from the requester and modified to fit a standardized format as needed.

In an example, analysis may begin by retrieving a travel data record from the dataset (306) (e.g., querying a database to retrieve a comprehensive trip record). Then, stress factor strength values may be received for the demographic category (e.g., as discussed in detail above with respect to stress factor data) of the traveler of the retrieved trip (308).

In some examples, the demographic information is already stored in a traveler database in operations database 216. However, if the demographic information is not available for a traveler, TSI system 202 may transmit a request to the requester (e.g., to user terminal 204) for the demographic information of travelers in the dataset. In various examples, different amounts of demographic information may be used. For example, in some TSI analyses, only gender and age may be used to segment travelers, while more detailed information may be used in other analyses (e.g., occupation, partner status, etc.). In various examples, based on the determined demographics, data on the strengths of various stress factors (Sᵢ) may be retrieved from previously conducted surveys.

In an example, the maximum possible lost time and actual lost time for the trip may be calculated using the retrieved stress factor strengths (310). For example, the trip may first be reconstructed to determine what activities occurred during the trip and when the activity occurred. This may be done by using transaction data in operations database 216, by accessing the comprehensive trip record (CTR) for the trip, or by querying external sources as needed. The maximum possible lost time may be determined by summing all durations Tᵢ across all possible stressful activities i for the trip. Each activity i may have a different Tᵢ value. The actual lost time may be calculated by summing all Sᵢ×Tᵢ across all possible stress activities i for the trip. In an example, if two or more activities occur at the same time, only one Tᵢ is counted for any overlapping time (e.g., that with the higher stress strength value).

In various examples, it is determined if other trips remain in the dataset (312), and if so, the flow goes back to block 306. Once the maximum possible lost time and actual lost time for each trip in the dataset are calculated, all of the maximum possible lost time (MPLT) and actual lost time (ALT) are calculated by summing across the entire trip dataset (314). The TSI may then be defined as the ratio of ALT to MPLT.

The financial equivalent FE of ALT may also be calculated (using the appropriate hourly rate from a benchmark compensation database) to give a reference point for the productivity lost due to travel stress. For example, benchmark financial information (total compensation including salary, social charges, and benefits) may be accessed in order to “convert time into money” and obtain a per hour compensation. Financial information may reside in a database which could be sorted by, for example, traveler country of residence, occupation, and traveler's job level in the organization.

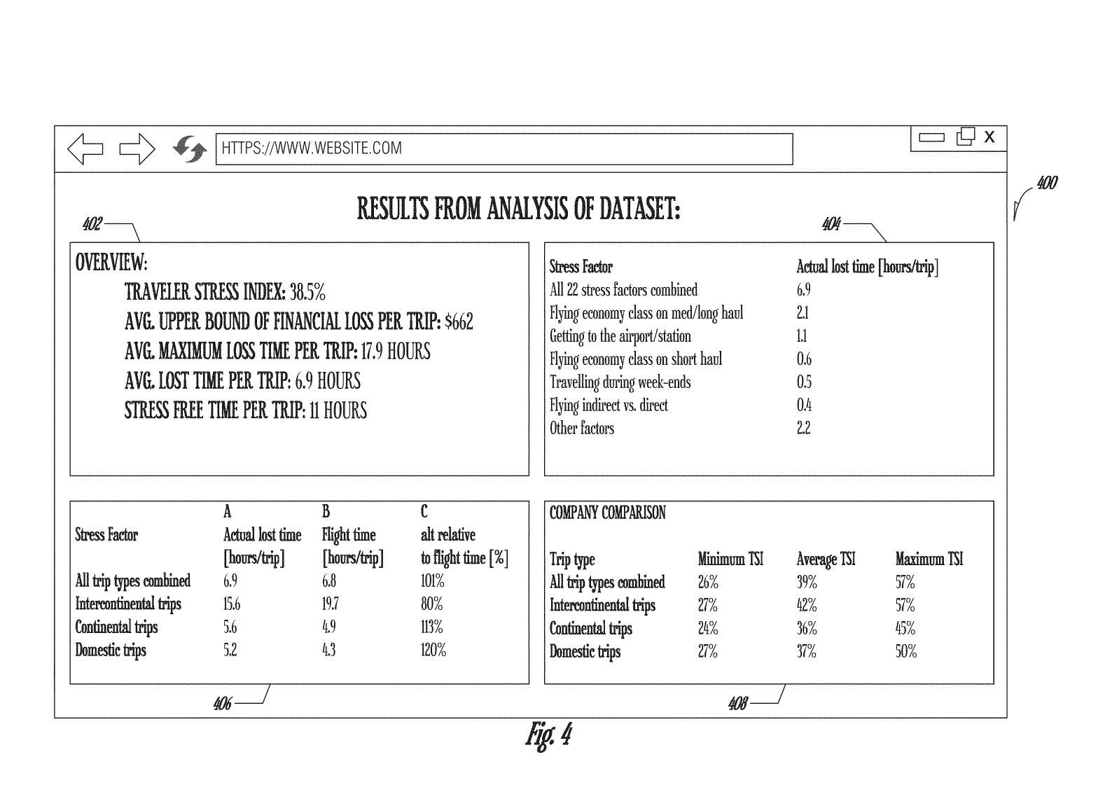

In various examples, the calculated TSI may be transmitted back to the requester and presented on a display screen. Additionally, TSI system 202 may generate a report that is presented (e.g., transmitted to user terminal 204 for display) to the requester. The report may allow a more detailed analysis of the dataset (see FIG. 4 for an example report). The report may be a stand-alone file or presented in a web format (e.g., HTML).

A TSI may be calculated for individual travelers, based on their recent trips (within the last year, for example). For example, the report may include breakdowns of TSI values by demographics and different clients within the dataset, or even breakdowns at individual traveler level. Thus, a requester may be presented with a chart that shows his/her company's TSI values as compared to the company's competitors. The report may also include a calculated financial equivalent (FE) based on the maximum productivity loss (e.g., using compensation data for the travelers).

In various examples, the results of applying the TSI model to a dataset are discussed below. First, the overall results obtained by using 15.3 million trips over a course of a year are given, and then the factors which triggered the highest levels of stress are identified. Second, overall results are broken down by trip type: intercontinental, continental, or domestic. Third and last, client-by-client variations of the TSI are discussed.

FIG. 4 is an example report interface 400 that may be presented to a user viewing the results of the TSI analysis. Interface portion 404 lists the actual lost time per trip for an ensemble of the stress factors (22 in this example), as well as for the top five factors in terms of their contribution to lost time. In an example, metrics obtained from analyzing a full set of trips for the dataset are presented in interface portion 402. Accordingly, for the analyzed dataset, the maximum possible lost time for the average trip is 17.9 hours; of this, 11 hours are “stress-free” (available to the traveler to either work or rest). The traveler experiences stress over the remaining 6.9 hours (integrated time duration).

In various examples, based on benchmark employment cost data, the financial equivalent of the 6.9 hours is $662, which, as explained in a previous section, constitutes an upper limit on the lost productivity per trip. To illustrate the magnitude of this financial equivalent, note that, in an example, it amounts to 79% of the average plane ticket price. For example, for a client with a travel volume of 5,000 air trips per year, the expected financial equivalent of actual lost time may be $3.3 million.

In various examples, the results may be broken down by trip type, as the trip type mix may be very different from client to client. Also of note may be examining how the lost time values stack up against the average flight duration for the trip. In an example, these results are shown in interface portion 406. In this portion, the flight time includes the combined durations of the inbound and outbound flights, along with the connection time for indirect flights. According to Column C of Table 3, the actual lost time and flight time are comparable: their ratio varies from 0.8 (intercontinental) to 1.2 (domestic).

As presented in interface portion 402, the TSI obtained by analyzing the combined set of trips was TSI=38.5%. In principle, a TSI may be calculated for any subset of trips, and in particular for subsets corresponding to individual companies (or even individual travelers). In an example, within a sample of companies in the dataset that recorded a minimum of 500 transactions per month, the TSI variations are shown interface portion 408. While not illustrated in FIG. 4, the computed metrics for individual subsets based on companies may be presented to a user. In various examples, the results presented in interface portion 408 reflect the fact that stress may not be reduced beyond a certain limit. For this dataset, the best-in-class TSI value is 26%, or about 4.7 hours per trip. This represents an improvement of 32% over the average lost time of 6.9 hours.

A new way of looking at business travel within the scope of traveler wellbeing has been presented in the above descriptions. In various examples, the methodology presented enables an organization to “put a metric behind a feeling” and shed light onto the hidden economics of business travel. Some of the findings included determining that, on average, stress may be experienced during 6.9 hours per trip. This may be referred to as “lost time,” or time unavailable to travelers to work or rest. The financial equivalent of this lost time may be $662 per trip; this value should not be interpreted as the actual lost productivity, but rather as an upper limit on this quantity. Additionally, in various examples, while lost time cannot be completely eliminated, there appears to be significant room for improvement. Indeed, companies may expect to control up to 32% of the lost time, on average.

Examining business travel from a TSI perspective may require a different approach. For example, beyond the purely transactional aspect of the trip, companies may recognize business travel as a strategic means to grow and compete effectively in the marketplace. Additionally, business travel has an impact on a company's most important asset: its employees. For these reasons, a broader stakeholder umbrella may be required in making travel policy decisions. This includes Human Resources and Responsible Business communities, as well as Procurement and Travel Management departments already involved in managing business travel today.

In various examples, the TSI may be used as a decision-making tool to help companies assess and adjust their travel policies, and move from “travel policy” to “traveler policy.” Traveling smarter rather than less may be the way to find a balance between the actual costs of travel and the hidden ones. This may help companies to address their duty of care responsibilities while ensuring their travelers focus on being productive.

By way of various examples, this disclosure introduces a methodology for quantifying the impact of business travel stress on an organization. This may allow an organization to assess a company's average stress level across travelers and to benchmark it against the industry norm. Recommendations may then be provided to help clients tackle the hidden costs of business travel.

The previous discussion focuses on the use of 15.3 million air trips booked within a 1-year period (the dataset); however, other datasets may be used and analyzed in a similar fashion (e.g., for a specific client or for comparison across clients). In an example, the geographical scope is global.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

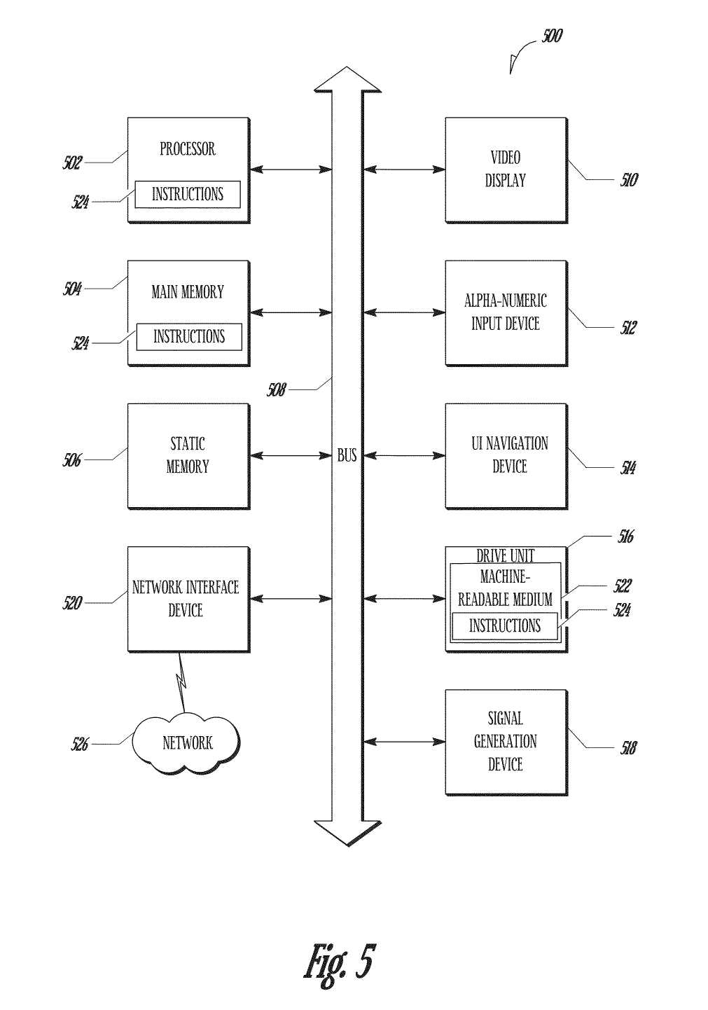

FIG. 5 is a block diagram of machine in the example form of a computer system 500 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a PC, a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU), or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a user interface (UI) navigation device 514 (e.g., a mouse), a disk drive unit 516, a signal generation device 518 (e.g., a speaker), and a network interface device 520.

### Machine-Readable Medium

The disk drive unit 516 includes a machine-readable medium 522 on which is stored one or more sets of instructions and data structures (e.g., software) 524 embodying or utilized by any one or more of the methodologies or functions described herein. The instructions 524 may also reside, completely or at least partially, within the main memory 504 and/or within the processor 502 during execution thereof by the computer system 500, with the main memory 504 and the processor 502 also constituting machine-readable media.

While the machine-readable medium 522 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 524 may further be transmitted or received over a communications network 526 using a transmission medium. The instructions 524 may be transmitted using the network interface device 520 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
retrieving a dataset, from a storage device, including transaction data on a plurality of trips;
calculating, using at least one processor, a maximum possible lost time value for each respective trip in at least a first subset of the plurality of trips;
calculating, using the at least one processor, an actual lost time value for each respective trip in the first subset;
summing the calculated maximum possible lost time values and actual lost time values to determine a total maximum possible lost time (MPLT) value for the first subset and a total actual lost time (ALT) value for the first subset, respectively; and
generating a stress index for the first subset by dividing the ALT value by the MPLT value.

2. The method of claim 1, wherein calculating the maximum possible lost time value for each respective trip in the first subset of the plurality of trips comprises:
retrieving transaction data for the respective trip, the transaction data including data associated with a plurality of activities of the respective trip;
retrieving a time associated with each activity in the plurality of activities; and
summing the retrieved times.

3. The method of claim 1, wherein calculating the actual lost time value for each respective trip in the first subset of the plurality of trips comprises:
retrieving transaction data for the respective trip, the transaction data including data associated with a plurality of activities of the respective trip;
for each activity in the plurality of activities:
retrieving a time associated with the respective activity;
retrieving a stress factor strength value for the respective activity; and
multiplying the time by the retrieved stress factor strength value to determine a lost time value for the respective activity; and
summing the lost time values for the plurality of activities.

4. The method of claim 3, wherein retrieving a stress factor strength value for the respective activity comprises:
determining a demographic category of a traveler associated with the respective trip; and
accessing the stress factor strength value for the respective activity from a plurality of stress factor strength values for the respective activity based on the demographic category.

5. The method of claim 3, further comprising:
determining that at least two activities in the plurality of activities overlap during a time period of the respective trip; and
using the greater of the stress factor strength values of the at least two activities when determining the lost time value for the time period in which the at least two activities overlap.

6. The method of claim 1, further comprising:
for each trip in the first subset of the plurality of trips:
retrieving an hourly compensation rate for a traveler associated with the respective trip; and
multiplying the hourly rate by the actual lost time value to determine a financial equivalent of the actual lost time value for the respective trip; and
generating a total financial equivalent for the first subset by summing the financial equivalents for each trip in the first subset.

7. The method of claim 6, wherein retrieving the hourly compensation rate for the traveler associated with the respective trip comprises:
determining an occupation of the traveler; and
retrieving the hourly compensation from a compensation database based on the occupation.

8. The method of claim 1, further comprising:
calculating, using at least one processor, a maximum possible lost time value for each respective trip in at least a second subset of the plurality of trips;
calculating, using the at least one processor, an actual lost time value for each respective trip in the second subset;
summing the calculated maximum possible lost time values and actual lost time values to determine a total MPLT value for the second subset and a total ALT value for the second subset, respectively
generating a stress index for the second subset by dividing the ALT value of the second subset by the MPLT value of the second subset; and
presenting a report comparing the stress index for the first subset to the stress index of the second subset.

9. A non-transitory computer-readable medium comprising instructions, which when executed by a computing system, configure the computing system to perform operations comprising:
retrieving a dataset, from a storage device, including transaction data on a plurality of trips;
calculating a maximum possible lost time value for each respective trip in at least a first subset of the plurality of trips;
calculating an actual lost time value for each respective trip in the first subset;
summing the calculated maximum possible lost time values and actual lost time values to determine a total maximum possible lost time (MPLT) value for the first subset and a total actual lost time (ALT) value for the first subset, respectively; and
generating a stress index for the first subset by dividing the ALT value by the MPLT value.

10. The non-transitory computer-readable medium of claim 9, wherein the operation of calculating the maximum possible lost time value for each respective trip in the first subset of the plurality of trips comprises:
retrieving transaction data for the respective trip, the transaction data including data associated with a plurality of activities of the respective trip;
retrieving a time associated with each activity in the plurality of activities; and
summing the retrieved times.

11. The non-transitory computer-readable medium of claim 9, wherein the operation of calculating the actual lost time value for each respective trip in the first subset of the plurality of trips comprises:
retrieving transaction data for the respective trip, the transaction data including data associated with a plurality of activities of the respective trip;
for each activity in the plurality of activities:
retrieving a time associated with the respective activity;
retrieving a stress factor strength value for the respective activity; and
multiplying the time by the retrieved stress factor strength value to determine a lost time value for the respective activity; and
summing the lost time values for the plurality of activities.

12. The non-transitory computer-readable medium of claim 11, wherein the operation of retrieving a stress factor value for the respective activity comprises:
determining a demographic category of a traveler associated with the respective trip; and
accessing the stress factor strength value for the respective activity from a plurality of stress factor values for the respective activity based on the demographic category.

13. The non-transitory computer-readable medium of claim 9, wherein the operations comprise:
for each trip in the first subset of the plurality of trips:
retrieving an hourly compensation rate for a traveler associated with the respective trip; and
multiplying the hourly rate by the actual lost time value to determine a financial equivalent of the actual lost time value for the respective trip; and
generating a total financial equivalent for the first subset by summing the financial equivalents for each trip in the first subset.

14. The non-transitory computer-readable medium of claim 13, wherein the operation of retrieving the hourly compensation rate for the traveler associated with the respective trip comprises:
determining an occupation of the traveler; and
retrieving the hourly compensation from a compensation database based on the occupation.

15. The non-transitory computer-readable medium of claim 9, wherein the operations comprise:
calculating a maximum possible lost time value for each respective trip in at least a second subset of the plurality of trips;
calculating an actual lost time value for each respective trip in the second subset;
summing the calculated maximum possible lost time values and actual lost time values to determine a total MPLT value for the second subset and a total ALT value for the second subset, respectively
generating a stress index for the second subset by dividing the total ALT value of the second subset by the total MPLT value of the second subset; and
presenting a report comparing the stress index for the first subset to the stress index of the second subset.

16. A system comprising:
a database with a dataset of transaction data for a plurality of trips stored thereon;
at least one processor;
a storage device with instructions stored thereon, which when executed by the at least one processor configure the at least one processor to:
retrieve the dataset from the database;
calculate a maximum possible lost time value for each respective trip in at least a subset of the plurality of trips;
calculate an actual lost time value for each respective trip in the first subset;
sum the calculated maximum possible lost time values and actual lost time values to determine a total maximum possible lost time (MPLT) value for the first subset and a total actual lost time (ALT) value for the first subset, respectively; and
generate a stress index for the subset by dividing the ALT value by the total MPLT value.

17. The system of claim 16, wherein to calculate the maximum possible lost time value for each respective trip in the first subset of the plurality of trips, the at least one processor is configured to:
retrieve transaction data for the respective trip, the transaction data including data associated with a plurality of activities of the respective trip;
retrieve a time associated with each activity in the plurality of activities; and
sum the retrieved times.

18. The system of claim 16, wherein the transaction data for the plurality of trips is arranged according to a plurality of activities of a trip.

19. The system of claim 18, wherein the actual lost time for a respective trip is calculated based on a plurality of stress factor strength values for the plurality of activities of the respective trip.
